(19) United States
(12) Patent Application Publication
(10) Pub. No.: US 2016/0187570 A1
(43) Pub. Date: Jun. 30, 2016

(54) DISPLAY APPARATUS

(71) Applicant: Samsung Display Co., Ltd., Yongin-City (KR)

(72) Inventor: Sangwoon JUNG, Seongnam-si (KR)

(21) Appl. No.: 14/691,061

(22) Filed: Apr. 20, 2015

(30) Foreign Application Priority Data
Dec. 26, 2014 (KR) 10-2014-0190583

(51) Int. Cl. F21V 8/00; G09G 5/10

(52) U.S. Cl. CPC G02B 6/0088; G09G 5/10; G02B 6/0031; G02B 6/005; G02B 6/0068

(57) ABSTRACT

A display apparatus includes: a display panel configured to display images using light; a backlight unit including a light source to emit the light; a first protection member configured to accommodate the backlight unit, including a plurality of coupling holes; and a guide member shaped in a frame and disposed on an outer surface and top of the first protection member, supporting an edge of the display panel on the top of the first protection member. The guide member is shaped like a hook and includes a plurality of connection members inserted into the coupling holes. The connection members in a predetermined number are disposed in an incident part defined by a region in which the light source is disposed and an opposite part facing the incident part.

### CROSS-REFERENCE TO RELATED APPLICATIONS

A claim for priority under 35 U.S.C. §119 is made to Korean Patent Application No. 10-2014-0190583 filed Dec. 26, 2014 in the Korean Intellectual Property Office, the entire contents of which are hereby incorporated by reference.

### BACKGROUND OF THE INVENTION

The present invention described herein relates to a display apparatus, and more particularly relates to a display apparatus capable of solidly fixing a guide member therein.

A display apparatus generally includes a display panel and a backlight unit supplying light to the display panel. The display panel expresses images by adjusting optical transmittance of light supplied from the backlight unit.

The backlight units may be generally classified into edge types where light is supplied to the display panel from the sides of the display panel, and direct types where light is supplied to the display panels from the bottom of the display panel. An edge-type backlight unit usually includes a light source for generating light, and a light guide plate for leading an emitting direction. The light source is usually disposed at a side of the light guide plate. The light guide plate functions to lead light to the display panel from the light source.

The backlight unit and the display panel may be fixedly accommodated in bottom and top sashes. Those bottom and top sashes may act to protect the backlight unit and the display panel.

### SUMMARY OF THE INVENTION

One aspect of embodiments of the present invention is directed to providing a display apparatus capable of solidly fixing a guide member therein and achieving a narrow bezel structure.

In an embodiment, the display apparatus may include: a display panel configured to display images using light; a backlight unit including a light source to emit the light; a first protection member configured to accommodate the backlight unit, including a plurality of coupling holes; and a guide member shaped in a frame and disposed on an outer surface and a top of the first protection member for supporting an edge of the display panel on the top of the first protection member. The guide member may be shaped as a hook, including a plurality of connection members inserted into coupling holes. The connection members in a predetermined number may be disposed in an incident part defined by a region in which the light source is disposed and an opposite part facing the incident part.

The first protection member may further include: a bottom having long sides in a first direction and short sides in a second direction intersecting the first direction; sidewalls extending upward from the sides of the bottom and including the coupling holes; and covers extending by a predetermined length along the second direction from top ends of the sidewalls facing each other in the second direction. The light source may be disposed on one side of the bottom in the second direction.

A part of the covers, which is disposed on the one side of the bottom, may be configured to cover the light source.

The coupling holes may include: a plurality of first coupling holes disposed on the sidewalls facing each other in the second direction; and a plurality of second coupling holes disposed on the sidewalls facing each other in the first direction.

The backlight unit may include: a reflection sheet disposed on the bottom; a light guide plate disposed on the reflection sheet; and an optical sheet disposed between the covers on the light guide plate. The light source may be disposed adjacent to one side of the light guide plate in the second direction, and a part of the covers, which is disposed on the other side of the bottom in the second direction, may be configured to cover a predetermined region of the other side of the light guide plate in the second direction.

The guide member may further include first and second guide members that are disposed to face each other in the same frame shape and that surround an edge of the display panel.

Each of the first and second guide members may include: a first extension part elongated in the second direction; and second extension parts elongated from both ends of the first extension part in the first direction. Ends of the second extension parts of the first guide member may be disposed to face ends of the second extension parts of the second guide member.

The connection members may include: first connection members disposed on inner surfaces of the second extension parts in correspondence with the first coupling holes; and second connection members disposed on inner surfaces of the first extension parts in correspondence with the second coupling holes.

Each of the first and second extension parts may include: a vertical part extending along a third direction intersecting the first and second directions; and a guide part extending inward from the first and second extension parts, orthogonal to the vertical part, from a top end of the vertical part. The first connection members may be correspondingly disposed on inner surfaces of the vertical parts of the second extension parts, and the second connection members may be disposed on inner surfaces of the vertical parts of the first extension parts.

The inner surfaces of the vertical parts of the first extension parts may be disposed to contact outer surfaces of the sidewalls facing each other in the first direction, and the inner surfaces of the vertical parts of the second extension parts may be disposed to contact outer surfaces of the sidewalls facing each other in the second direction.

The guide parts of the first extension parts may be disposed on the sidewalls facing each other in the first direction, and the guide parts of the second extension parts may be disposed on the sidewalls and covers that face each other in the second direction.

The guide parts of the second extension parts may be shorter than the covers in the second direction.

The display panel may be interposed between the guide parts, and the guide parts may support the edge of the display panel.

Each of the first connection members may be inserted into a corresponding first coupling hole of the first coupling holes, and each of the second connection members may be inserted into a corresponding second coupling hole of the second coupling holes.

The display apparatus according to embodiments of the present invention is advantageous for solidly fixing a guide member therein and for accomplishing a narrow bezel structure.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a disassembled perspective view illustrating a display apparatus in accordance with an embodiment of the present invention.

FIG. 2 is an explosive view illustrating an inner surface of the first guide member shown in FIG. 1.

FIG. 3 is a sectional view taken along I-I′ of FIG. 1.

FIG. 4 is a second view illustrating a display apparatus in accordance with another embodiment of the present invention.

### DETAILED DESCRIPTION OF THE INVENTION

Advantages and features of the present invention, and ways for accomplishing them will be apparent from embodiments described in detail hereinafter in conjunction with the accompanying drawings. The present invention, however, may be embodied in various different forms, and should not be construed as being limited only to the illustrated embodiments. Rather, these embodiments are provided as examples so that this disclosure will be thorough and complete, and will fully convey the concept of the present invention to those skilled in the art. The present invention may be properly defined in the scope of the annexed claims. Unless otherwise noted, the same reference numerals denote the same elements throughout the attached drawings.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present. As used herein, the term “and/or” includes any and all combinations of one or more of the associated listed items.

Spatially relative terms, such as “beneath”, “below”, “lower”, “under”, “above”, “upper”, and the like may be used herein for ease of description to explain one element or feature's relationship to another element(s) or feature(s) as illustrated in the drawings. It will be understood that the spatially relative terms are intended to encompass different orientations of the device in use or operation in addition to the orientation depicted in the drawings. For example, if the device in the drawings is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that, when a layer is referred to as being “between” two layers, it can be the only layer between the two layers, or one or more intervening layers may also be present.

It will be understood that, although the terms “first”, “second”, “third”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The embodiments described in the specification will be illustrated with reference to idealized schematics, and plan and sectional views. Such illustrations may be modified depending on fabrication techniques and/or permissible variations. Accordingly, the embodiments of the present invention may not be construed as restrictive thereto, but rather may be viewed as including other varieties, even allowable deviations or errors, arising from fabrication processes. Regions or areas exemplified in the drawings may have generic characters and exemplary patterns of the regions may be just provided for particular forms not limiting the scope of the present invention.

Hereinafter, exemplary embodiments of the present invention will be described in conjunction with accompanying drawings.

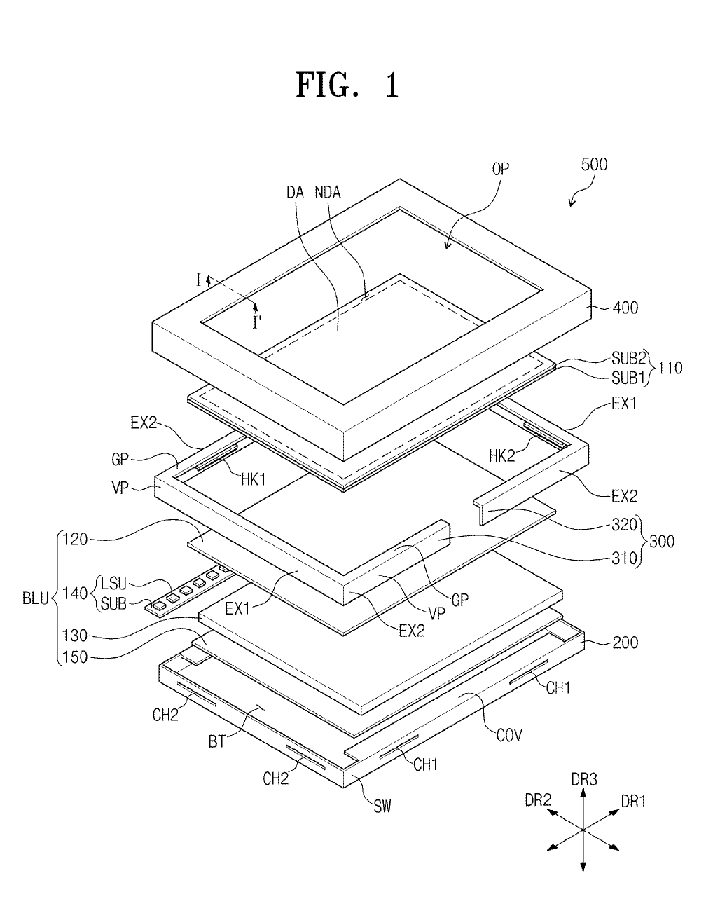

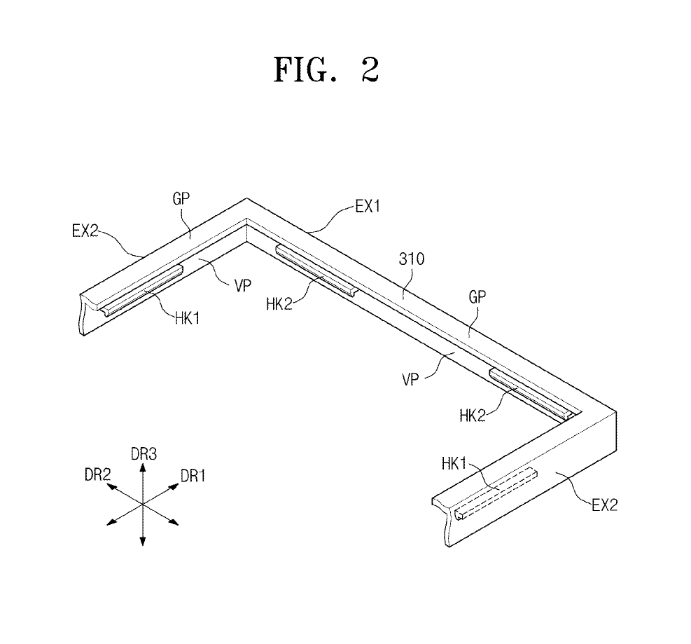

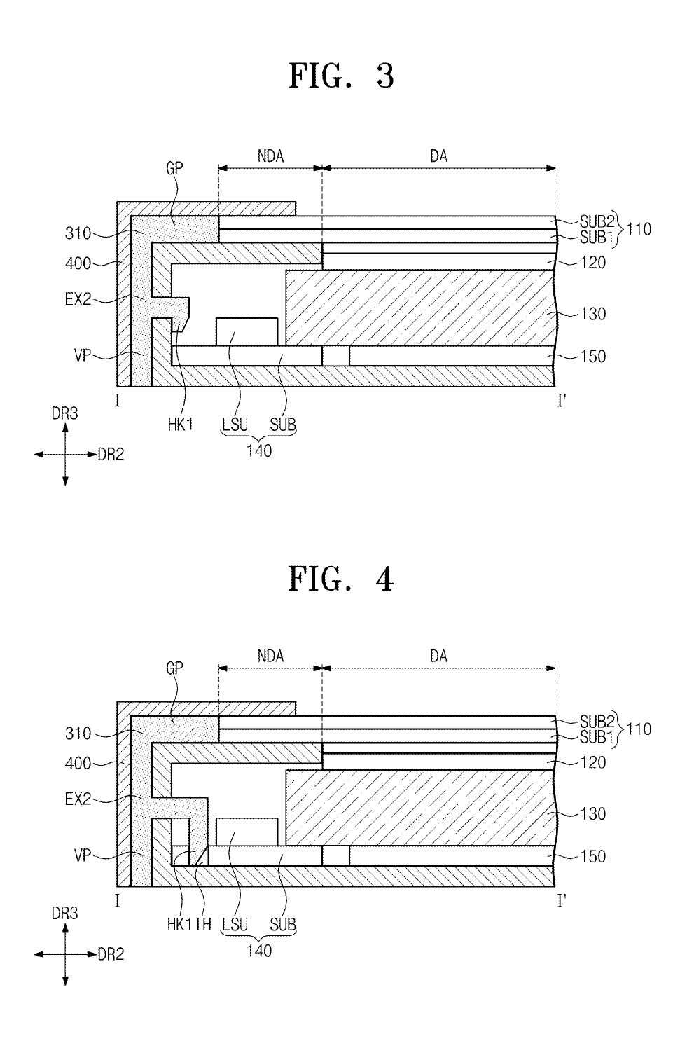

FIG. 1 is a disassembled perspective view illustrating a display apparatus in accordance with an embodiment of the present invention, FIG. 2 is an explosive view illustrating an inner surface of the first guide member shown in FIG. 1, and FIG. 3 is a sectional view taken along I-I′ of FIG. 1.

Referring to FIG. 1, the display apparatus 500 may include a display panel 110, a backlight unit BLU supplying light to the display panel 110, and protection members 200, 300 and 400 accommodating and protecting the display panel 110 and the backlight unit BLU. The backlight unit BLU may be disposed at the rear of the display panel 110 for supplying light to the display panel 110.

Although not shown, the display panel 110 may include a plurality of pixels displaying images using light. A plane region of the display panel 110 includes a display area DA in which the pixels are arranged, and a non-display area NDA surrounding the display area DA (see FIG. 3).

The display panel 110 may be a kind of liquid crystal display panel including a liquid crystal layer. That is, the display panel 110 may include a first substrate SUB1 on which the plural pixels are arranged, a second substrate SUB2 facing the first substrate SUB1, and a liquid crystal layer interposed between the first and second substrates SUB1 and SUB2 (see FIG. 3).

The backlight unit BLU may be made in an edge type. The backlight unit BLU includes an optical sheet 120, a light guide plate 130, a light source 140, and a reflection sheet 150 (see FIG. 1).

The display panel 110, the optical sheet 120, the light guide plate 130, the light source 140 and the reflection sheet 150 may have long sides in a first direction DR1, respectively, and short sides in a second direction DR2 intersecting the first direction DR1.

The light source 140 may be disposed adjacent to one side of the light guide plate 130 in the second direction DR2, and the optical sheet 120 may be disposed on the top of the light guide plate 130. The display panel 110 may be placed on top of the optical sheet 120.

The light source 140 may generate and supply light to the light guide plate 130 of the display panel 110. The light source 140 may include a light source substrate SUB extending toward the first direction DR1, and a plurality of light source units mounted on the light source substrate SUB.

The light source substrate SUB may have long sides in the first direction DR1, and short sides in the second direction DR2. The light source units LSU may be disposed with a uniform interval along the first direction DR1. The light source units LSU generate light. Light generated from the light source units LSU may be supplied to one side of the light guide plate 130 in the second direction DR2.

The light guide plate 130 may direct light upward toward the display panel 110 from the light source 140. The reflection sheet 150 may reflect light, which is diffused out and downward from the light guide plate 130, in the upward direction.

By operation of the light guide plate 130, light led upward may be diffused and concentrated through the light source sheet 120, and then supplied to the display panel 110.

The optical sheet 120 may include a diffusion sheet (not shown), and a prism sheet (not shown) disposed on the top of the diffusion sheet. The diffusion sheet may act to diffuse light from the light guide plate 130.

The prism sheet may act to concentrate light, which is spread by the diffusion sheet, in the upward direction and vertical with respect to the plane. The light passing through the prism sheet may proceed upward so as to be supplied to the display panel 110 with a uniform luminance distribution. The pixels of the display panel 110 may express images using the light supplied thereto.

The protection members 200, 300 and 400 may include a first protection member 200, a guide member 300, and a second protection member 400. The first protection member 200 accommodates the backlight unit BLU.

In detail, the first protection member 200 may include a bottom BT, sidewalls SW, and two covers COV. The bottom BT may be shaped as a rectangle having long sides in the first direction DR1 and short sides in the second direction DR2.

The sidewalls SW may extend respectively from sides of the bottom BT upward in a third direction DR3 that is vertical to the first and second directions DR1 and DR2, respectively. That is, the sidewalls SW may bend upward from the sides of the bottom BT.

The sidewalls SW may include a plurality of coupling holes CH1 and CH2. In an exemplary embodiment, as shown in FIG. 1, each of the sidewalls SW may include two of the coupling holes CH1 and CH2. However, without being restricted thereto, each of the sidewalls SW may include more than two of the coupling holes CH1 and CH2.

The coupling holes CH1 and CH2 may include a plurality of first coupling holes CH1 disposed on the sidewalls SW and which face each other in the second direction DR2, and a plurality of second coupling holes CH2 disposed on the sidewalls SW and which face each other in the first direction DR1.

The covers COV may extend with a predetermined length, facing each other in the second direction DR2 on the top ends of one pair of the sidewalls SW. For instance, the covers COV may extend by a predetermined length in the second direction DR2 on the top ends of the sidewalls SW which face each other in the second direction DR2. Ends of the two covers COV may be disposed so as to face each other.

The first coupling holes CH1 may be disposed in the sidewalls SW which join with the covers COV. The second coupling holes CH2 may be disposed in the sidewalls SW that do not join with the covers COV.

The reflection sheet 150 may be accommodated in the first protection member 200, settling on the bottom BT of the first protection member 200.

The light source 140 may be disposed on the bottom BT of one of regions in which the covers COV are placed. For example, the light source 140 may be disposed at one side of the bottom BT in the second direction DR2. The covers COV disposed on the top of one side of the bottom BT may cover the light source 140.

The light guide plate 130 may be accommodated in the first protection member 200 and disposed on the reflection sheet 150. In the second direction DR2, one side of the light guide plate 130 may be adjacent to the light source units LSU. In the second direction DR2, one side of the light guide plate 130 may be defined as an incident plane, while the other side may be defined as an opposite plane. In the second direction DR2, one side of the reflection sheet 150 may be adjacent to the light source substrate SUB.

In the second direction DR2, the cover COV disposed on one side of the bottom BT may cover a predetermined region of one side of the light guide plate 130 in the second direction DR2. Although not shown in the section of FIG. 3, substantially the cover COV disposed on the other side of the bottom BT in the second direction DR2 may cover a predetermined region of the other side of the light guide plate 130 in the second direction DR2.

The optical sheet 120 may be accommodated in the first protection member 200 and disposed on the light guide plate 130. The optical sheet 120 may be interposed between the covers COV.

The guide member 300 may buffer an impact inflicted thereon, being made of a plastic that is easy to fabricate. The guide member 300 may be disposed with a predetermined frame pattern on the outer surface and top of the first protection member 200, supporting the edge of the display panel 110 on the top of the first protection member 200.

In detail, the guide member 300 may include first and second guide members 310 and 320, respectively, which may be arranged to face each other with frames shaped in ‘ [symbol] ’ form. The first and second guide members 310 and 320, respectively, may be disposed so as to surround the edge of the display panel 110.

Each of the first and second guide members 310 and 320, respectively, may include a first extension part EX1 elongated along the second direction DR2, and second extension parts EX2 elongated along the first direction DR1 from both ends of the first extension part EX1. Accordingly, the first and second guide members 310 and 320, respectively, may be shaped in frames like ‘ [symbol] ’.

Ends of the second extension parts EX2 of the first and second guide members 310 and 320, respectively, may be arranged to face one another.

The first and second extension parts EX1 and EX2, respectively, may each include vertical parts VP extending along the third direction DR3, and guide parts GP, orthogonal to the vertical parts VP, extending inward from the first and second extension parts EX1 and EAX2, respectively, from top ends of the vertical parts VP.

The first guide member 310 may include a plurality of connection members HK1 and HK2 set in the inner surfaces of the vertical parts VP of the first and second extension parts EX1 and EX2, respectively. FIG. 2 simply illustrates the first guide member 310 for the sake of descriptive convenience, whereas the second guide member 320 may also include the connection members HK1 and HK2 the same as the first guide member 310.

The connection members HK1 and HK2 may include a plurality of first connection members HK1 disposed on the inner surfaces of the second extension parts EX2, and a plurality of connection members HK2 disposed on the inner surfaces of the first extension part EX1.

The first connection members HK1 may be disposed in correspondence with the first coupling holes CH1. The second connection members HK2 may be disposed in correspondence with the second coupling holes CH2. The first and second connection members HK1 and HK2, respectively, may be shaped in the same pattern as hooks.

The first connection members HK1 may be correspondingly disposed on the inner surfaces of the vertical parts VP of the second extension parts EX2. That is, the first connection members HK1 may be disposed so as to correspond one by one with the inner surfaces of the vertical parts VP. The second connection members HK2 may be disposed on the inner surfaces of the vertical parts VP of the first extension parts EX1.

The inner surfaces of the vertical parts VP of the first extension parts EX1 may be disposed so as to contact the outer surfaces of the sidewalls facing each other in the first direction DR1. The inner surfaces of the vertical parts VP of the second extension parts EX2 may be disposed so as to contact the outer surfaces of the sidewalls SW facing each other in the second direction DR2.

The guide parts GP of the first extension parts EX1 may be disposed on the sidewalls SW facing each other in the first direction DR1. The guide parts GP of the second extension parts EX2 may be disposed on the sidewalls SW and covers COV which face each other in the second direction DR2. In the second direction DR2, the guide parts GP of the second extension parts EX2 may be shorter in length than covers COV.

The first connection members HK1 may each be inserted thereinto so as to join with their corresponding first coupling holes CH1. The second connection members HK2 may each be inserted thereinto so as to join with their corresponding second coupling holes CH2. Accordingly, the first and second guide members 310 and 320, respectively, may be connected with the first protection member 200.

The guide member 300 exemplarily includes the first and second connection members HK1 and HK2, respectively, whereas it is not restrictive thereto but may include only the first connection members HK1. Even if the first connection members HK1 are inserted to link with the first coupling holes CH1, the first and second guide members 310 and 320, respectively, may be connected with the first protection member 200.

The display panel 110 placed on the optical sheet 120 may be interposed between the guide parts GP of the first and second extension parts EX1 and EX2, respectively. That is, the edge of the display panel 100 may be supported by the guide parts GP of the first and second guide members 310 and 320, respectively.

The second protection member 400 may be disposed on the display panel 110. The second protection member 400 may be shaped as a frame that has long sides extending along the first direction DR1 and short sides extending along the second direction DR2.

The second protection member 400 may include an open area OP corresponding to the display area DA of the display panel 110. The second protection member 400 may be overlaid with the non-display area NDA of the display panel 110, while contacting the outer surface of the guide member 300. Accordingly, the display area DA of the display panel 110 may be disclosed through the open area OP of the display panel 110.

Hereinafter, a region in which the light source 140 is placed will be referred to as an incident part, while a predetermined region in which the opposite plane of the light guide plate 130 is placed will be referred to as an opposite part facing the incident part.

If the covers respectively provided on the incident and opposite parts are formed in notches, without the hook-type connection members HK1 and HK2, predetermined regions of the covers COV may be cut off to make connection parts that are bent upward. Additionally, in this case, it may be allowable to make holes for rendering the connection parts to be inserted into the guide parts which are placed on the incident and opposite parts. As the connection parts of the covers COV are inserted into the holes of the guide parts, the guide member 300 is connected with the first protection member 200.

On the other hand, if there is a gap between the connection parts and holes in dimensions, it may not be accomplishable to stably connect the guide member 300 with the first protection member 200. Furthermore, as the guide parts of the guide member 300 become smaller in width for the sake of a narrow bezel structure, it becomes more difficult to form such holes for the insertion.

In embodiments of the present invention, the first and second connection members HK1 and HK2, respectively, with hook patterns may be disposed on the inner surfaces of the vertical parts VP of the first and second guide members 310 and 320, respectively. Namely, the first connection members HK1, which are shaped as a hook not a notch, may be disposed in the incident and opposite parts.

As the hooked first and second connection members HK1 and HK2, respectively, are inserted into the first and second coupling holes CH1 and CH2, respectively, it may be attainable to connect the guide member 300 more firmly with the first protection member 200. Additionally, as there is no need to form the holes in the guide parts GP, the widths of the guide parts GP may be narrow to facilitate a narrow bezel structure,

Consequently, the display apparatus 500 according to embodiments of the present invention may be advantageous in stably fastening the guide member 300 and obtaining a narrow bezel structure.

FIG. 4 is a second view illustrating a display apparatus in accordance with another embodiment of the present invention.

Except for the configuration with the light source substrate SUB and the first connection members 500 being placed in the incident part, the display apparatus exemplified in FIG. 4 is same as that of FIG. 1. For descriptive convenience by partial differentiation, FIG. 4 shows the section by I-I′ of FIG. 1, but then hereinafter delineates the light source substrate SUB and the first connection members HK1 placed in the incident part.

Insertion holes IH, which correspond to the first connection members HK1 which are placed in the incident part, may be disposed on the light source substrate SUB between the light sources LSU and the sidewall SW which is placed in the incident part. The first connection members HK1 placed in the incident part may be shaped as hooks.

After the first connection members HK1 placed in the incident part are inserted respectively into their corresponding first coupling holes CH1, respective ends of the first connection members HK1 may be inserted into their corresponding insertion holes IH.

As the first connection members HK1 are inserted into the first coupling holes CH1 and the insertion holes IH of the light source substrate SUB, the guide member 300 may be fastened to the first protection member 200 and the light source substrate SUB may be fastened to the guide member 300.

While an adhesive tape has been conventionally used to fasten the light source substrate SUB, the embodiments of the present invention are practiced by employing the guide member 300 for settling the light source substrate SUB and may not use such an adhesive tape therefor.

Therefore, the display apparatus according to this embodiment of the present invention may stably fasten the guide member 300 so as to accomplish a narrow bezel structure, the guide member 300 contributing to fastening even the light source substrate SUB.

While the present invention has been described with reference to exemplary embodiments, it will be apparent to those skilled in the art that various changes and modifications may be made without departing from the spirit and scope of the present invention as set forth throughout the annexed claim matters. Therefore, it should be understood that the above embodiments are not limiting but are illustrative, and thus all technical aspects or features within the annexed claims and the equivalents thereof may be construed as properly belonging to the scope of the present invention.

What is claimed is:

1. A display apparatus, comprising:
a display panel configured to display images using light;
a backlight unit including a light source to emit the light;
a first protection member configured to accommodate the backlight unit and including a plurality of coupling holes; and
a guide member shaped as a frame and disposed on an outer surface and a top of the first protection member for supporting an edge of the display panel on the top of the first protection member;
wherein the guide member is shaped as a hook, including a plurality of connection members inserted into the coupling holes, wherein the connection members in a predetermined number are disposed in an incident part defined by a region in which the light source is disposed and an opposite part facing the incident part.

2. The display apparatus according to claim 1, wherein the first protection member further includes:
a bottom having long sides in a first direction and short sides in a second direction intersecting the first direction;
sidewalls extending upward from the sides of the bottom and including the coupling holes; and
covers extending by a predetermined length along the second direction from top ends of the sidewalls facing each other in the second direction;
wherein the light source is disposed on one side of the bottom in the second direction.

3. The display apparatus according to claim 2, wherein a part of the covers, which is disposed on the one side of the bottom, is configured to cover the light source.

4. The display apparatus according to claim 2, wherein the coupling holes include:
a plurality of first coupling holes disposed on the sidewalls facing each other in the second direction; and
a plurality of second coupling holes disposed on the sidewalls facing each other in the first direction.

5. The display apparatus according to claim 4, wherein the backlight unit includes:
a reflection sheet disposed on the bottom;
a light guide plate disposed on the reflection sheet; and
an optical sheet interposed between the covers on the light guide plate;
wherein the light source is disposed adjacent to one side of the light guide plate in the second direction, and a part of the covers, which is disposed on the other side of the bottom in the second direction, is configured to cover a predetermined region of another side of the light guide plate in the second direction.

6. The display apparatus according to claim 4, wherein the guide member further includes first and second guide members that are disposed so as to face each other in the same frame shape and so as to surround an edge of the display panel.

7. The display apparatus according to claim 6, wherein each of the first and second guide members includes:
a first extension part elongated in the second direction; and
second extension parts elongated from both ends of the first extension part in the first direction;
wherein ends of the second extension parts of the first guide member are disposed to face ends of the second extension parts of the second guide member.

8. The display apparatus according to claim 7, wherein the connection members include:
a plurality of first connection members disposed on inner surfaces of the second extension parts in correspondence with the first coupling holes; and
a plurality of second connection members disposed on inner surfaces of the first extension parts in correspondence with the second coupling holes.

9. The display apparatus according to claim 8, wherein each of the first and second extension parts includes:
a vertical part extending along a third direction intersecting the first and second directions; and
a guide part extending inward from the first and second extension parts, and orthogonal to the vertical part, from a top end of the vertical part;
wherein the first connection members are correspondingly disposed on inner surfaces of the vertical parts of the second extension parts, and the second connection members are disposed on inner surfaces of the vertical parts of the first extension parts.

10. The display apparatus according to claim 9, wherein the inner surfaces of the vertical parts of the first extension parts are disposed so as to contact outer surfaces of the sidewalls facing each other in the first direction, and the inner surfaces of the vertical parts of the second extension parts are disposed so as to contact outer surfaces of the sidewalls facing each other in the second direction.

11. The display apparatus according to claim 9, wherein the guide parts of the first extension parts are disposed on the sidewalls facing each other in the first direction, and the guide parts of the second extension parts are disposed on the sidewalls and covers that face each other in the second direction.

12. The display apparatus according to claim 9, wherein the guide parts of the second extension parts are shorter than the covers in the second direction.

13. The display apparatus according to claim 9, wherein the display panel is interposed between the guide parts, and the guide parts are configured to support the edge of the display panel.

14. The display apparatus according to claim 9, wherein each of the first connection members is inserted into a corresponding first coupling hole of the first coupling holes; and
wherein each of the second connection members is inserted into a corresponding second coupling hole of the second coupling holes.

15. The display apparatus according to claim 8, wherein the light source includes:
a light source substrate having long sides in the first direction and short sides in the second direction; and
a plurality of light source units disposed on the light source substrate and configured to generate the light.

16. The display apparatus according to claim 15, wherein the light source substrate includes a plurality of insertion holes disposed between the light source units and the sidewall placed in the incident part.

17. The display apparatus according to claim 16, wherein each of the first connection members disposed in the incident part is inserted into a corresponding first coupling hole of the first coupling holes, and then each of ends of the first connection members is inserted into a corresponding insertion hole of the insertion holes.

18. The display apparatus according to claim 1, further comprising a second protection member disposed on the display panel, being overlaid with a non-display area surrounding a display area in the display panel, and disposed so as to contact an outer surface of the guide member;
wherein the second protection member includes an open area to disclose the display area of the display panel.
